(19) United States
(12) Patent Application Publication
(10) Pub. No.: US 2023/0203279 A1
(43) Pub. Date: Jun. 29, 2023

(54) ADHESION PREVENTIVE AGENT FOR UNVULCANIZED RUBBER AND AQUEOUS DISPERSION OF ADHESION PREVENTIVE AGENT FOR UNVULCANIZED RUBBER

(71) Applicant: LION SPECIALTY CHEMICALS CO., LTD., Tokyo (JP)

(72) Inventor: TAKUYA SOGA, Tokyo (JP)

(73) Assignee: LION SPECIALTY CHEMICALS CO., LTD., Tokyo (JP)

(21) Appl. No.: 17/938,936

(22) Filed: Sep. 7, 2022

(30) Foreign Application Priority Data
Dec. 24, 2021 (JP) 2021-211712

(51) Int. Cl. C08K 13/02

(52) U.S. Cl. CPC C08K 13/02

(57) ABSTRACT

The disclosure provides an adhesion preventive agent for unvulcanized rubber, the adhesion preventive agent containing smectite and having excellent adhesion prevention, fluidity, dispersion solubility, and dried matter washability. An adhesion preventive agent for unvulcanized rubber of the disclosure contains components (A) to (D): (A) smectite; (B) a compound represented by Chemical Formula (1), (C) a surfactant other than the component (B); and (D) at least one substance selected from the group consisting of an inorganic silicate other than the component (A), an inorganic carbonate, an inorganic sulfate, a metal oxide, a metal hydroxide, red iron oxide, carbon black, graphite, and a metal soap. R′—O—(PO)m-H . . . (1) In Chemical Formula (1), R¹ is a linear or branched hydrocarbon group having 4 to 20 carbon atoms, PO is an oxypropylene group, and m represents the average addition molar number of PO, and is a number of 12 to 40.

### CROSS-REFERENCE TO RELATED APPLICATIONS

This application claims the priority benefit of Japanese Patent Application No. 2021-211712, filed on Dec. 24, 2021. The entirety of the above-mentioned patent application is hereby incorporated by reference herein and made a part of this specification.

### BACKGROUND

### Technical Field

The disclosure relates to an adhesion preventive agent for unvulcanized rubber, and an aqueous dispersion of an adhesion preventive agent for unvulcanized rubber.

### Description of Related Art

In production and processing sites of rubber such as natural rubber (NR), butadiene rubber (BR), and styrene butadiene rubber (SBR), unvulcanized rubber molded into a sheet shape or the like may be stacked or folded and stored until the unvulcanized rubber is transferred to a subsequent step such as molding or vulcanization. An adhesion preventive agent (close adhesion preventive agent) is attached to the surface of the unvulcanized rubber for the purpose of preventing close adhesion between unvulcanized rubber and unvulcanized rubber during such storage (for example, Patent Document 1 or the like).

### PATENT DOCUMENTS

Patent Document 1: Japanese Patent Laid-Open No. 2013-001720

### SUMMARY

As a component of the adhesion preventive agent for unvulcanized rubber, smectite having a high effect of improving adhesion prevention is frequently used. When an adhesion preventive agent for unvulcanized rubber containing smectite is made into a treatment liquid (aqueous dispersion of the adhesion preventive agent for unvulcanized rubber), the treatment liquid has a high viscosity, and when the treatment liquid is dried, a firm dried film (adhesion preventive film) can be obtained, and thus adhesion prevention is excellent. Meanwhile, when the content ratio (blending amount) of the smectite in the adhesion preventive agent for unvulcanized rubber is increased, there is a risk of the fluidity of a high-concentration treatment liquid (aqueous dispersion of the adhesion preventive agent for unvulcanized rubber) decreasing, undispersed substances being generated due to a decrease in dispersion solubility, or a decrease in dried matter washability or the like occurring.

Accordingly, the disclosure provides: an adhesion preventive agent for unvulcanized rubber, the adhesion preventive agent containing smectite and having excellent adhesion prevention, fluidity, dispersion solubility, and dried matter washability; and an aqueous dispersion of the adhesion preventive agent for unvulcanized rubber.

According to an embodiment, an adhesion preventive agent for unvulcanized rubber of the disclosure contains the following components (A) to (D):

(A) smectite;

(B) a compound represented by Chemical Formula (1),

R¹—O—(PO)m-H (1)

in Chemical Formula (1),

R¹ is a linear or branched hydrocarbon group having 4 to 20 carbon atoms,

PO is an oxypropylene group, and

m represents the average addition molar number of PO, and is a number of 12 to 40;

(C) a surfactant other than the component (B); and

(D) at least one substance selected from the group consisting of an inorganic silicate other than the component (A), an inorganic carbonate, an inorganic sulfate, a metal oxide, a metal hydroxide, red iron oxide, carbon black, graphite, and a metal soap.

According to another embodiment, an aqueous dispersion of an adhesion preventive agent for unvulcanized rubber of the disclosure contains the adhesion preventive agent for unvulcanized rubber of the disclosure, and water.

According to the disclosure, it is possible to provide: an adhesion preventive agent for unvulcanized rubber, the adhesion preventive agent containing smectite and having excellent adhesion prevention, fluidity, dispersion solubility, and dried matter washability; and an aqueous dispersion of the adhesion preventive agent for unvulcanized rubber.

### DESCRIPTION OF THE EMBODIMENTS

Hereinafter, the disclosure will be described in more detail. However, the disclosure is not limited by the following description.

[1. Adhesion Preventive Agent for Unvulcanized Rubber]

As described above, the adhesion preventive agent for unvulcanized rubber according to the disclosure contains the following components (A) to (D):

(A) smectite;

(B) a compound represented by Chemical Formula (1),

R¹—O—(PO)m-H (1)

in Chemical Formula (1),

R¹ is a linear or branched hydrocarbon group having 4 to 20 carbon atoms,

PO is an oxypropylene group, and

m represents the average addition molar number of PO, and is a number of 12 to 40;

(C) a surfactant other than the component (B); and

(D) at least one substance selected from the group consisting of an inorganic silicate other than the component (A), an inorganic carbonate, an inorganic sulfate, a metal oxide, a metal hydroxide, red iron oxide, carbon black, graphite, and a metal soap.

The adhesion preventive agent for unvulcanized rubber and the aqueous dispersion of the adhesion preventive agent for unvulcanized rubber according to the disclosure contain smectite, which is the component (A), and the components (B) to (D), and thus have excellent adhesion prevention, fluidity, dispersion solubility, and dried matter washability. Moreover, “dispersion” in the disclosure includes “dissolution.” For example, the description that the adhesion preventive agent for unvulcanized rubber according to the disclosure is “dispersed” in water means that, among the components of the adhesion preventive agent for unvulcanized rubber according to the disclosure, the water-soluble components are dissolved in water and the water-insoluble components are dispersed in water. Furthermore, such a phenomenon may be referred to as “dispersion and dissolution” in the following description.

The adhesion preventive agent for unvulcanized rubber according to the disclosure may contain, for example, 20 to 80% by mass of the component (A), 0.1 to 5% by mass of the component (B), 5 to 20% by mass of the component (C), and 0.1% by mass or greater of the component (D), with respect to 100% by mass of the total mass of the components other than water. As will be described later, the content ratio of each component is preferably within the aforementioned numerical range, for example, from the viewpoint of the balance of the adhesion prevention and slipperiness with usability (for example, water dispersibility, dried matter washability, or liquid fluidity) of the adhesion preventive agent for unvulcanized rubber.

[1-1. Component (A): Smectite]

In the adhesion preventive agent for unvulcanized rubber according to the disclosure, the smectite (which may hereinafter be referred to as “smectite (A)”), which is the component (A), is not particularly limited, but examples thereof include smectite such as montmorillonite, beidellite, nontronite, saponite, hectorite, sauconite, or stevensite, and bentonite containing montmorillonite. The component (A) may include only one kind of smectite or two or more kinds of smectite may be used in combination.

The component (A) functions, for example, as a component responsible for adhesion prevention. Specifically, it is considered that the component (A) can exhibit adhesion prevention, for example, by forming a film. The content ratio of the component (A) in the adhesion preventive agent for unvulcanized rubber according to the disclosure is not particularly limited and can be selected according to the intended purpose, but is preferably 20% by mass to 80% by mass, more preferably 30% by mass to 80% by mass, still more preferably 40% by mass to 80% by mass, even more preferably 35% by mass to 80% by mass, and even still more preferably 40% by mass to 80% by mass, with respect to 100% by mass of the total mass of the components other than water. When the content ratio of the component (A) is 20% by mass or greater with respect to 100% by mass of the total mass of the components other than water, favorable adhesion prevention is obtained, and thus the above range is preferable. Meanwhile, when the content ratio of the component (A) is 80% by mass or less, the water dispersibility, the dried matter washability, and the effect of improving the fluidity of a concentrated treatment liquid of the disclosure can be more effectively obtained, and thus the above range is preferable.

The component (A) (smectite) may be used, for example, in the form of an inorganic compound (for example, a powder of the inorganic compound or the like) containing smectite. In this case, a method for measuring the content of the smectite in the inorganic compound is not particularly limited, but the content of the smectite can be measured by, for example, the following measuring method.

(Method for Measuring Content of Smectite)

An inorganic compound containing smectite is analyzed by X-ray diffraction, and the content of smectite is calculated from the intensity of a smectite-derived diffraction peak that appears near 2θ of 7°. The analysis conditions for X-ray diffraction when quantifying the content of smectite are as follows.

Analysis Conditions for X-Ray Diffraction
Measuring device: X'Pert PRO MRD (manufactured by PANalytical)
Target: Cu
Tube voltage: 45 kV
Tube current: 40 mA
Scan axis: Gonio
Scan range: 5° to 60°
Step size: 0.03°
Step time: 12.7 seconds
Divergence slit: 1/2°
Scattering slit: 1°
Light receiving slit: None

[1-2. Component (B): Compound Represented by Chemical Formula (1)]

In the adhesion preventive agent for unvulcanized rubber according to the disclosure, the component (B) is a compound represented by Chemical Formula (1), as described above.

R¹—O—(PO)m-H (1)

In Chemical Formula (1),

R¹ is a linear or branched hydrocarbon group having 4 to 20 carbon atoms,

PO is an oxypropylene group, and

m represents the average addition molar number of PO, and is a number of 12 to 40.

The component (B) is considered to contribute to, for example, improvement in water dispersibility, improvement in dried matter washability, improvement in the fluidity of a concentrated treatment liquid, and the like in the adhesion preventive agent for unvulcanized rubber and the aqueous dispersion of the adhesion preventive agent for unvulcanized rubber according to the disclosure.

The component (B) is considered to act as, for example, a penetrating agent in the adhesion preventive agent for unvulcanized rubber and the aqueous dispersion of the adhesion preventive agent for unvulcanized rubber according to the disclosure. Specifically, the component (B) is considered to facilitate the introduction of water into, for example, a lump or a firm dried film formed of smectite and thus contribute to reduction of undispersed substances and improvement in dried matter washability. Moreover, blending of the component (B) is considered to have, for example, an effect of inhibiting the structure formation of smectite in a treatment liquid (aqueous dispersion of the adhesion preventive agent for unvulcanized rubber). In particular, the blending of the component (B) can reduce the viscosity at the time of high concentration (high-concentration aqueous dispersion of the adhesion preventive agent for unvulcanized rubber).

In the component (B), R¹ in Chemical Formula (1) is a linear or branched hydrocarbon group having 4 to 20 carbon atoms, as described above. The number of carbon atoms in R¹ is 4 to 20 as described above, preferably 4 to 18, more preferably 4 to 12, and still more preferably 4 to 8, from the viewpoint of the balance between hydrophilicity and hydrophobicity of the component (B).

In the component (B), m in Chemical Formula (1) represents the average addition molar number of an oxypropylene group (PO), and is a number of 12 to 40, as described above. m may be, for example, 12 or more, 14 or more, 16 or more, 40 or less, 36 or less, or 34 or less. The numerical value of m can be appropriately set, for example, from the viewpoint of the interaction between the component (A) and the component (B). When the numerical value of m is equal to or more than the lower limit value and equal to or less than the upper limit value, the viscosity at the time of high concentration can be reduced.

The content ratio of the component (B) in the adhesion preventive agent for unvulcanized rubber according to the disclosure is not particularly limited and can be selected according to the intended purpose, but is preferably 0.1% by mass to 5% by mass, more preferably 0.5% by mass to 4% by mass, and still more preferably 1% by mass to 3% by mass, with respect to 100% by mass of the total mass of the components other than water. In order to obtain more effective adhesion prevention, it is preferable that the content ratio of the component (B) be low. In order to obtain sufficient water dispersibility and dried matter washability, and a sufficient effect of improving the fluidity of a concentrated treatment liquid, it is preferable that the content ratio of the component (B) be high.

[1-3. Component (C): Surfactant Other than Component (B)]

The component (C) is a surfactant other than the component (B), as described above. The component (C) (which may hereinafter be referred to as a “surfactant (C)”) is considered to have, for example, a function of imparting wettability with rubber and water dispersibility to the adhesion preventive agent for unvulcanized rubber and the aqueous dispersion of the adhesion preventive agent for unvulcanized rubber according to the disclosure.

The surfactant (C) (the component (C)) is not particularly limited, but examples thereof include the following (1) to (5) and the like. Moreover, as the surfactant (C), only one kind of surfactant may be used, or two or more kinds thereof may be used in combination.

(1) A carboxylic acid-type anionic surfactant such as a higher fatty acid salt, an alkyl ether carboxylate, a polyoxyalkylene ether carboxylate, an alkyl (or alkenyl) amide ether carboxylate, or an acylaminocarboxylate

(2) A sulfuric acid ester-type anionic surfactant such as a higher alcohol sulfuric acid ester salt, a polyoxyalkylene higher alcohol sulfuric acid ester salt, an alkylphenyl ether sulfuric acid ester salt, a polyoxyalkylene alkylphenyl ether sulfuric acid ester salt, or a glycerin fatty acid ester monosulfuric acid ester salt

(3) A sulfonic acid-type anionic surfactant such as an alkane sulfonate, an α-olefin sulfonate, a linear alkylbenzene sulfonate, an α-sulfo fatty acid ester salt, or a dialkyl sulfosuccinate

(4) A phosphoric acid ester-type anionic surfactant such as an alkyl phosphoric acid ester salt, a polyoxyalkylene alkyl phosphoric acid ester salt, a polyoxyalkylene alkylphenyl phosphoric acid ester salt, or a glycerin fatty acid ester monophosphoric acid ester salt

(5) A polyoxyalkylene alkyl ether-type nonionic surfactant

The counterion of the anionic surfactant is not particularly limited, but an alkali metal such as sodium or potassium, and an alkanolamine such as monoethanolamine or diethanolamine are preferable. Only one kind thereof may be used alone, or two or more kinds thereof may be used in combination.

The anionic surfactant is preferably an α-olefin sulfonate or a dialkyl sulfosuccinate since an adhesion preventive agent suspension having superior wettability with the surface of unvulcanized rubber is obtained, and the α-olefin sulfonate is more preferably sodium α-olefin sulfonate “LIPOLAN LB-840” (produced by Lion Specialty Chemicals Co., Ltd.), and the dialkyl sulfosuccinate is more preferably sodium dioctyl sulfosuccinate.

The nonionic surfactant is not particularly limited, but in the disclosure, for example, a nonionic surfactant represented by Chemical Formula (2) can be used. The nonionic surfactant represented by Chemical Formula (2) is presumed to exhibit, together with the anionic surfactant, an action of effectively increasing attachment of the adhesion preventive agent to the surface of the unvulcanized rubber in addition to the reduction of the surface tension of the adhesion preventive agent suspension with respect to the surface of the unvulcanized rubber. However, this presumption does not limit the disclosure at all.

R²O-(AO)ₙ—H (2)

In Chemical Formula (2), R² represents an aliphatic hydrocarbon group having 8 to 18 carbon atoms. The aliphatic hydrocarbon group may be linear or branched. Moreover, the aliphatic hydrocarbon group may be saturated or unsaturated. The number of carbon atoms in R² is preferably 10 to 16 and more preferably 12 to 14, from the viewpoint of the excellent dispersibility of the component (A).

In Chemical Formula (2), AO represents an oxyalkylene group having 2 to 4 carbon atoms, and n is the average addition molar number of AO. n is not particularly limited, but is preferably 1 to 30, more preferably 1 to 25, and still more preferably 1 to 15. Specifically, n is preferably 1 or more (that is, n is not 0) from the viewpoint of preventing the degradation of the surface active ability and the degradation of the dispersibility of the component (A). Moreover, n preferably does not exceed 30 and more preferably does not exceed 25, from the viewpoint of preventing degradation of attachment due to excessively high hydrophilicity. When n is preferably in the range of 1 to 30 and more preferably in the range of 1 to 25, it is presumed that the dispersibility of the component (A) is further improved, and even if the hydrophobicity of the surface of the unvulcanized rubber is high, the attachment is improved by imparting sufficient viscoelasticity for the coating. However, this presumption does not limit the disclosure at all.

Furthermore, in the disclosure, the oxyalkylene group having 2 to 4 carbon atoms is, for example, a polymerization unit obtained through the addition of an alkylene oxide having 2 to 4 carbon atoms (formed through addition polymerization). The oxyalkylene group having 2 to 4 carbon atoms is specifically an oxyethylene group (EO) obtained through the addition of ethylene oxide, an oxypropylene group (PO) obtained through the addition of propylene oxide, or an oxybutylene group (BO) obtained through the addition of butylene oxide. (AO)ₙ includes at least an oxyethylene group in the structure thereof. When (AO)ₙ includes a plurality of kinds of groups among an oxyethylene group (EO), an oxypropylene group (PO), and an oxybutylene group (BO), these groups may be arranged in a block shape or arranged randomly. The preferred (AO)ₙ in the surfactant (C) represented by Chemical Formula (2) is composed of only an oxyethylene group (EO) from the viewpoint of the excellent balance between hydrophilicity and hydrophobicity of the surfactant (C).

In the adhesion preventive agent for unvulcanized rubber according to the disclosure, only one kind of the surfactant (C) may be used, or any plurality of kinds thereof may be used in combination, but the combined use of the anionic surfactant and the nonionic surfactant is preferable from the viewpoint that the combined use gives the adhesion preventive agent for unvulcanized rubber excellent wettability and attachment. The content ratio of the surfactant (C) in the adhesion preventive agent for unvulcanized rubber according to the disclosure is not particularly limited and can be selected according to the intended purpose, but is preferably 5 to 20% by mass with respect to 100% by mass of the total mass of the components other than water. It is preferable that the content ratio of the surfactant (C) not be too low from the viewpoint of preventing the phenomenon in which cissing occurs due to insufficient wettability with rubber. Moreover, it is preferable that the content ratio of the surfactant (C) not be too high from the viewpoint of preventing the phenomenon in which foaming increases and overflow from facilities occurs when using the adhesion preventive agent for unvulcanized rubber.

[1-4. Component (D)]

The component (D) is at least one substance selected from the group consisting of an inorganic silicate other than the component (A), an inorganic carbonate, an inorganic sulfate, a metal oxide, a metal hydroxide, red iron oxide, carbon black, graphite, and a metal soap, as described above. The component (D) is considered to act as, for example, a lubricant (to impart slipperiness to the adhesion preventive agent for unvulcanized rubber). Moreover, the component (D) is considered to impart adhesion prevention to the adhesion preventive agent for unvulcanized rubber, for example, as an auxiliary to the component (A). The component (D) is not particularly limited, only one kind thereof may be used, or a plurality of kinds thereof may be used in combination, but it is preferable to include at least one selected from the group consisting of a metal soap (fatty acid metal salt), kaolin, mica, talc, and calcium carbonate from the viewpoint of improving adhesion prevention and improving slipperiness.

The inorganic silicate other than the component (A) (smectite) in the component (D) is not particularly limited, but examples thereof include silicates such as kaolin, aluminum silicate, calcium silicate, clay, talc, mica, sericite, and nepheline syenite. The inorganic carbonate is not particularly limited, but examples thereof include carbonates such as calcium carbonate, magnesium carbonate, and barium carbonate. The inorganic sulfate is not particularly limited, but examples thereof include sulfates such as calcium sulfate and barium sulfate. The metal oxide is not particularly limited, but examples thereof include a metal oxide such as silica, alumina, magnesium oxide, antimony trioxide, titanium oxide, white carbon, or iron oxide. The metal hydroxide is not particularly limited, but examples thereof include a metal hydroxide such as aluminum hydroxide, magnesium hydroxide, or iron hydroxide.

In addition, the component (D) may include, for example, a component (D1), that is, at least one metal soap (fatty acid metal salt) selected from the group consisting of zinc, magnesium, and aluminum. The inclusion of the metal soap is considered to reduce the hardness of the adhesion preventive agent for unvulcanized rubber and improve the adhesion prevention. Moreover, specific examples of the component (D1) and the like will be described later. Examples of the metal soap include a calcium salt and a barium salt of a fatty acid in addition to the component (D1). The calcium salt and barium salt of the fatty acid are not particularly limited, but may be, for example, a salt obtained by changing the metal (at least one metal selected from the group consisting of zinc, magnesium, and aluminum) of the component (D1), which will be described later, to calcium or barium. Further, the respective metal soaps according to these examples are water-insoluble salts and do not correspond to anionic surfactants. The component (D) preferably further includes at least one of the inorganic carbonate and the inorganic silicate other than smectite, and it is preferable that the component (D) include at least one of kaolin, mica, talc, and calcium carbonate among them since the hardness of the adhesion preventive agent for unvulcanized rubber is further reduced. From the viewpoint of reducing hardness, it is more preferable to include calcium carbonate and still more preferable to include at least one of kaolin, mica, and talc together with calcium carbonate. Furthermore, the combined use of kaolin and mica and/or talc is preferable since superior adhesion prevention is obtained.

The at least one metal soap (D1) (which is component (D1) and may hereinafter be referred to as a “metal soap (D1)”) selected from the group consisting of zinc, magnesium, and aluminum is not particularly limited, but examples thereof include at least one kind of metal soap selected from the group consisting of zinc caprylate, magnesium caprylate, zinc caprate, magnesium caprate, zinc laurate, magnesium laurate, zinc myristate, magnesium myristate, zinc palmitate, magnesium palmitate, zinc stearate, magnesium stearate, aluminum stearate, aluminum trioctadecanoate, aluminum dioctadecanoate, aluminum monooctadecanoate, zinc octadecanoate, magnesium octadecanoate, zinc oleate, magnesium oleate, zinc behenate, magnesium behenate, zinc 12-hydroxystearate, magnesium 12-hydroxystearate, zinc 14-octadecanoate, magnesium 14-octadecanoate, zinc 8-octadecanoate, magnesium 8-octadecanoate, zinc 6-octadecanoate, magnesium 6-octadecanoate, coconut fatty acid zinc, coconut fatty acid magnesium, palm oil fatty acid zinc, palm oil fatty acid magnesium, palm kernel oil fatty acid zinc, palm kernel oil fatty acid magnesium, beef tallow fatty acid zinc, beef tallow fatty acid magnesium, castor oil fatty acid zinc, and castor oil fatty acid magnesium.

It is considered that the incorporation of the metal soap (D1), together with the component (A), in the adhesion preventive agent for unvulcanized rubber according to the disclosure reduces the hardness of the dried film of the adhesion preventive agent formed on the surface of the unvulcanized rubber and reduces foreign substances in the rubber while obtaining sufficient adhesion prevention. Moreover, the metal soap (D1) can also improve adhesion prevention.

The content ratio of the metal soap (D1) in the adhesion preventive agent for unvulcanized rubber according to the disclosure may be, for example, 2% by mass or greater or 5% by mass or greater with respect to the total mass of the component (D). Moreover, the content ratio (mass) of the metal soap (D1) is, for example, 50% by mass or less, and may be 35% by mass or less, 25% by mass or less, or 15% by mass or less, with respect to the total mass of the component (D). When the content ratio of the metal soap (D1) in the component (D) is set to 2% by mass or greater, the hardness of a dried solidified product can be reduced and favorable adhesion prevention can be obtained. Meanwhile, when the content ratio of the metal soap (D1) in the component (D) is set to 50% by mass or less, the sufficient effects of reducing the hardness of the dried solidified product of the adhesion preventive agent and suppressing foreign substances are obtained, and scattering of the film formed on the surface of the unvulcanized rubber is suppressed, and thus the above range is preferable. Further, the aforementioned components (D) other than the component (D1) can be sufficiently blended.

In addition, the content ratio of the component (D) is preferably, for example, 1% by mass to 25% by mass, and may be 2% by mass to 20% by mass, 3% by mass to 15% by mass, or 3% by mass to 10% by mass, with respect to the total mass of the components (A) to (C). When the content ratio of the component (D) is within the above range, for example, an effect of reducing the hardness of the dried solidified product of the adhesion preventive agent according to the disclosure and an effect of suppressing foreign substances can be sufficiently obtained, a film that is not easily scattered is formed on the surface of the unvulcanized rubber, and the aforementioned components (D) other than the component (D1) can be sufficiently blended and thus favorable slipperiness can also be obtained. Accordingly, the above range is preferable.

The content ratio of the component (D) in the adhesion preventive agent for unvulcanized rubber according to the disclosure is not particularly limited and can be selected according to the intended purpose, but may be, for example, 0.1% by mass or greater, 1% by mass or greater, 5% by mass or greater, 15% by mass or greater, or 25% by mass or greater and may be, for example, 70% by mass or less, 65% by mass or less, 60% by mass or less, or 55% by mass or less, with respect to 100% by mass of the total mass of the components other than water. In order to obtain more effective adhesion prevention, it is preferable that the content ratio of the component (D) be low. In order to obtain the sufficient effects of reducing the hardness of the dried solidified product of the adhesion preventive agent and suppressing foreign substances, it is preferable that the content ratio of the component (D) be high.

[1-5. Ratios of Contents of Components (A) to (D)]

The ratios of the contents of the components (A) to (D) in the adhesion preventive agent for unvulcanized rubber according to the disclosure are not particularly limited, but are as follows, for example.

(1) Component A/Component B (Mass Ratio)

The mass ratio (component A/component B) of the component (A) to the component (B) is not particularly limited, but may be, for example, 1 or greater, 10 or greater, 15 or greater, or 20 or greater, and may be, for example, 800 or less, 200 or less, 100 or less, or 80 or less.

(2) Component B/Component C (Mass Ratio)

The mass ratio (component B/component C) of the component (B) to the component (C) is not particularly limited, but may be, for example, 0.01 or greater, 0.02 or greater, 0.05 or greater, or 0.08 or greater, and may be, for example, 5 or less, 2 or less, 1 or less, or 0.5 or less.

(3) Component A/Component D (Mass Ratio)

The mass ratio (component A/component D) of the component (A) to the component (D) is not particularly limited, but may be, for example, 0.1 or greater, 0.2 or greater, 0.5 or greater, or 1 or greater, and may be, for example, 30 or less, 20 or less, 15 or less, or 10 or less.

(4) Component B/Component D (Mass Ratio)

The mass ratio (component B/component D) of the component (B) to the component (D) is not particularly limited, but may be, for example, 0.001 or greater, 10 or greater, 15 or greater, or 20 or greater, and may be, for example, 1 or less, 0.5 or less, 0.4 or less, or 0.3 or less.

(5) (Component A+Component D)/Component B (Mass Ratio)

The mass ratio ((component A+component D)/component B) of the total mass of the component (A) and the component (D) to the component B is not particularly limited, but may be, for example, 1 or greater, 10 or greater, 15 or greater, or 20 or greater, and may be, for example, 1,000 or less, 500 or less, 200 or less, or 100 or less.

(6) (Component A+Component D)/(Component B+Component C) (Mass Ratio)

The mass ratio ((component A+component D)/(component B+component C)) of the total mass of the component (A) and the component (D) to the total mass of the component (B) and the component (C) is not particularly limited, but may be, for example, 1 or greater, 2 or greater, 3 or greater, or 4 or greater, and may be, for example, 30 or less, 20 or less, 15 or less, or 10 or less.

[1-6. Optional Components]

The adhesion preventive agent for unvulcanized rubber according to the disclosure may or may not contain optional components other than the components (A) to (D). Examples of the optional components include an alcohol-based solvent.

The alcohol-based solvent is not particularly limited, and only one kind thereof may be used, or two or more kinds thereof may be used in combination. Examples of the alcohol-based solvent include a monohydric alcohol, a polyhydric alcohol, and a glycol-based solvent. The monohydric alcohol is not particularly limited, but, for example, a monohydric alcohol having a linear or branched alkyl group or alkenyl group having 1 to 24 carbon atoms is preferable, and specific examples thereof include ethanol, 1-propanol, 2-propanol, butanol, hexanol, 1-octanol, 2-ethylhexyl alcohol, decanol, lauryl alcohol, myristyl alcohol, cetyl alcohol, stearyl alcohol, and oleyl alcohol. The polyhydric alcohol is not particularly limited, but examples thereof include ethylene glycol, propylene glycol, glycerin, diethylene glycol, dipropylene glycol, and polyethylene glycol having a molecular weight of 100 to 1,000. The number of carbon atoms in the alkyl group or alkenyl group may be, for example, 4 or more, 6 or more, or 8 or more. The glycol-based solvent is not particularly limited, but examples thereof include a solvent obtained by addition-polymerizing 1 to 5 mol of an oxyalkylene group having 2 to 5 carbon atoms to a linear or branched alcohol having 1 to 8 carbon atoms. More specific examples thereof include: EO (1 to 5 mol) adducts of an alcohol having 1 to 8 carbon atoms, such as ethylene glycol monobutyl ether, diethylene glycol monobutyl ether, triethylene glycol monobutyl ether, ethylene glycol monohexyl ether, diethylene glycol monohexyl ether, triethylene glycol monohexyl ether, ethylene glycol mono 2-ethylhexyl ether, diethylene glycol mono 2-ethylhexyl ether, and triethylene glycol mono 2-ethylhexyl ether; and PO (1 to 5 mol) adducts of an alcohol having 1 to 8 carbon atoms, such as propylene glycol monobutyl ether, dipropylene glycol monobutyl ether, tripropylene glycol monobutyl ether, propylene glycol monohexyl ether, dipropylene glycol monohexyl ether, tripropylene glycol monohexyl ether, propylene glycol mono 2-ethylhexyl ether, dipropylene glycol mono 2-ethylhexyl ether, and tripropylene glycol mono 2-ethylhexyl ether. The number of carbon atoms in the alkyl group or alkenyl group is not particularly limited, but may be, for example, 2 to 8 or 4 to 8.

The content ratio of the alcohol-based solvent in the adhesion preventive agent for unvulcanized rubber according to the disclosure can be selected according to the intended purpose, but may be, for example, 1% by mass to 15% by mass, 2% by mass to 12% by mass, or 3% by mass to 10% by mass, with respect to the total mass of the components (A) to (D) and the alcohol-based solvent. It is preferable to set the content ratio of the component (F) within the above range from the viewpoint that the content of the component (F) within the above range makes the adhesion preventive agent for unvulcanized rubber have excellent adhesion prevention, sedimentation properties, and solubility.

Examples of the optional components other than the alcohol-based solvent include additives such as an antifoaming agent, a wettability auxiliary agent, a viscosity auxiliary agent, and a foreign substance reducing auxiliary agent.

The antifoaming agent is not particularly limited, and examples thereof include: an oil or fat-based antifoaming agent such as castor oil, sesame oil, linseed oil, or animal and vegetable oils; a fatty acid ester-based antifoaming agent such as isoamyl stearate, distearyl succinate, ethylene glycol distearate, or butyl stearate; an alcohol-based antifoaming agent such as polyoxyalkylene monohydric alcohol or di-t-amylphenoxyethanol; an ether-based antifoaming agent such as di-t-amylphenoxyethanol, 3-heptyl cellosolve, nonyl cellosolve, or 3-heptyl carbitol; a phosphoric acid ester-based antifoaming agent such as tributyl phosphate or tris(butoxyethyl) phosphate; an amine-based antifoaming agent such as diamylamine; an amide-based antifoaming agent such as polyalkylene amide or acylate polyamine; mineral oil; and silicone oil. Only one kind of the antifoaming agent may be used, or two or more kinds thereof may be used in combination.

The wettability auxiliary agent is not particularly limited, and examples thereof include alcohols, and more specific examples thereof include methanol, ethanol, glycerin, 1,3-butanediol, propylene glycol, dipropylene glycol, pentylene glycol, hexylene glycol, sorbitol, maltitol, sucrose, erythritol, xylitol, polyethylene glycol, polypropylene glycol, and an adduct of ethylene oxide or propylene oxide of a polyhydric alcohol. Only one kind of the wettability auxiliary agent may be used, or two or more kinds thereof may be used in combination.

The viscosity auxiliary agent is not particularly limited, and examples thereof include water-soluble polymers, and more specific examples thereof include: a synthetic water-soluble polymer such as protein, polyacrylic acid, sodium polyacrylate, polyacrylamide, polyvinyl alcohol, polyvinyl pyrrolidone, polyethylene glycol, polyethylene oxide, a water-soluble urethane resin, a water-soluble melamine resin, a water-soluble epoxy resin, a water-soluble butadiene resin, or a water-soluble phenol resin; and a natural water-soluble polymer such as xanthan gum, guar gum, welan gum, locust bean gum, diutan gum, tamarind gum, tamarind seed gum, tragacanth gum, gum arabic, carrageenan, rhamsan gum, succinoglycan, tara gum, gellan gum, karaya gum, pectin, an alginic acid derivative, or cellulose ethers. Only one kind of the viscosity auxiliary agent may be used, or two or more kinds thereof may be used in combination.

Moreover, the adhesion preventive agent for unvulcanized rubber according to the disclosure may contain water, for example, for the purpose of suppressing the flow of the powder or the like. In this case, the content ratio of the water is not particularly limited, and is, for example, about 2 to 3% by mass.

[2. Method for Producing Adhesion Preventive Agent for Unvulcanized Rubber, Aqueous Dispersion for Unvulcanized Rubber, Unvulcanized Rubber Subjected to Adhesion Prevention Treatment, and the Like]

The adhesion preventive agent for unvulcanized rubber according to the disclosure contains the components (A) to (D), as described above. The content ratio of the smectite (component (A)) is not particularly limited, but is, for example, as described above. Moreover, smectite is distributed in a state of containing water in some cases, but when the content of smectite is mentioned in the disclosure, the content of smectite is a value that does not include the amount of water.

A method for producing the adhesion preventive agent for unvulcanized rubber according to the disclosure is not particularly limited, but the adhesion preventive agent for unvulcanized rubber can be produced, for example, by mixing all the components (the components (A) to (D) and optional components to be blended as needed) of the adhesion preventive agent for unvulcanized rubber. As a device used for the mixing, for example, a device having a configuration in which a stirring blade is provided in a container can be used. Specifically, for example, a powder mixer, which performs oscillation stirring or stirring, such as a ribbon-type mixer or a vertical screw-type mixer can be mentioned. Moreover, a multifunctional powder mixer, such as SUPER MIXER (manufactured by KAWATA MFG. CO., LTD.), HIGH SPEED MIXER (manufactured by EARTHTECHNICA CO., LTD.), NEW-GRA MACHINE (manufactured by SEISHIN ENTERPRISE Co., Ltd.), or SV MIXER (manufactured by KOBELCO ECO-SOLUTIONS Co., Ltd.), in which a plurality of stirring devices is combined can also be used. Furthermore, a dry-type crusher, such as a jaw crusher, a gyratory crusher, a cone crusher, a roll crusher, an impact crusher, a hammer crusher, a rod mill, a ball mill, a vibrating rod mill, a vibrating ball mill, a disk-type mill, a jet mill, or a cyclone mill, may be used.

In addition, when at least one type of liquid component among all the components (the components (A) to (D) and optional components to be blended as needed) of the adhesion preventive agent for unvulcanized rubber is used, a spray device, shower device, or the like, which sprays or sprinkles the liquid component to a mixture excluding the liquid component, may be used in combination.

When a powdery adhesion preventive agent for unvulcanized rubber is used, the ratio of the total mass of the components (A) to (D) to the total mass of the powdery adhesion preventive agent may be 100% by mass. Moreover, when water and/or the other optional components are contained, the ratio of the total mass of the components (A) to (D) is not particularly limited, but is, for example, 80% by mass or greater, preferably 85% by mass to 97% by mass, and more preferably 85% by mass to 95% by mass, with respect to the total mass of the adhesion preventive agent for unvulcanized rubber.

The adhesion preventive agent for unvulcanized rubber according to the disclosure can be used, for example, as the aqueous dispersion of an adhesion preventive agent for unvulcanized rubber according to the disclosure. A method for producing the aqueous dispersion of an adhesion preventive agent for unvulcanized rubber according to the disclosure is not particularly limited, and, for example, after mixing all the components of the adhesion preventive agent for unvulcanized rubber according to the disclosure as described above to produce the adhesion preventive agent for unvulcanized rubber according to the disclosure, the adhesion preventive agent may be dispersed in water. Moreover, for example, the respective components of the adhesion preventive agent for unvulcanized rubber according to the disclosure may be each dissolved or dispersed in water, and mixed in water to obtain the aqueous dispersion of the adhesion preventive agent for unvulcanized rubber according to the disclosure. A method for dissolving or dispersing each of the aforementioned components is also not particularly limited, and, for example, the powdery adhesion preventive agent for unvulcanized rubber may be dispersed in a predetermined amount of water in a stirring tank. The total content of the components (A) to (D) in the aqueous dispersion of the adhesion preventive agent for unvulcanized rubber according to the disclosure is not particularly limited, but may be, for example, 0.5% by mass to 10% by mass, 0.5% by mass to 8% by mass, 0.5% by mass to 6% by mass, or 0.5% by mass to 4% by mass, with respect to the total mass of the aqueous dispersion of the adhesion preventive agent for unvulcanized rubber according to the disclosure.

In the case of an aqueous dispersion of an adhesion preventive agent for unvulcanized rubber, the total content of the components (A) to (D) may be, for example, 90% by mass to 100% by mass, 90% by mass to 99% by mass, or 93% by mass to 98% by mass, with respect to the total mass of the components other than water in the aqueous dispersion of an adhesion preventive agent for unvulcanized rubber.

When the aqueous dispersion of the adhesion preventive agent for unvulcanized rubber is produced as described above, the aqueous dispersion can be applied as it is to the surface of the unvulcanized rubber by a wet method or the like, which will be described later, and then used. Moreover, when the aqueous dispersion of the adhesion preventive agent for unvulcanized rubber is produced as described above, if the component (B1) includes at least one of a zinc salt and a magnesium salt, the viscosity of the aqueous dispersion of the adhesion preventive agent for unvulcanized rubber is increased, and thus the aqueous dispersion is likely to be uniformly applied when the aqueous dispersion is applied to the unvulcanized rubber by a wet method or the like, which will be described later. Accordingly, it is preferable that the component (B1) include at least one of a zinc salt and a magnesium salt. In particular, the magnesium salt exhibits favorable thickening properties even when the blending amount (content ratio) of the smectite (component (A)) is small, and thus is more preferable.

A method for producing unvulcanized rubber, which has been subjected to an adhesion prevention treatment, by using the adhesion preventive agent for unvulcanized rubber according to the disclosure includes, for example, an adhesion prevention treatment step of attaching the adhesion preventive agent for unvulcanized rubber according to the disclosure to the surface of the unvulcanized rubber and performing an adhesion prevention treatment. Even if the unvulcanized rubber, which has been subjected to the adhesion prevention treatment, produced as described above are stacked or folded and stored, the unvulcanized rubber does not closely adhere to other unvulcanized rubber, for example.

The adhesion prevention treatment step may be, for example, a step of attaching the adhesion preventive agent for unvulcanized rubber according to the disclosure to the surface of the unvulcanized rubber by attaching the aqueous dispersion of the adhesion preventive agent for unvulcanized rubber according to the disclosure to the surface of the unvulcanized rubber and volatilizing water. More specifically, the adhesion prevention treatment step preferably involves a suspension attachment step (aqueous dispersion attachment step) of attaching the aqueous dispersion (adhesion preventive agent suspension) of the adhesion preventive agent for unvulcanized rubber according to the disclosure to the surface of the unvulcanized rubber, and a drying step of drying the adhesion preventive agent suspension on the surface of the unvulcanized rubber to form a film formed of the adhesion preventive agent on the surface of the unvulcanized rubber. Such an adhesion prevention treatment step is referred to as, for example, a wet method.

In the method for producing unvulcanized rubber, which has been subjected to an adhesion prevention treatment, according to the disclosure, the wet method is not particularly limited, and can be carried out in the same manner as the wet method in typical adhesion preventive agents for unvulcanized rubber, for example. The concentration of the adhesion preventive agent for unvulcanized rubber according to the disclosure in the adhesion preventive agent suspension (aqueous dispersion) is, for example, as described above, and more specifically, may be set to, for example, 2 to 3% by mass, but the concentration is not limited to the numerical value and can be arbitrarily adjusted.

In the suspension attachment step, for example, it is preferable to attach the adhesion preventive agent suspension to the unvulcanized rubber which is in a high-temperature state (for example, about 80° C. to 150° C.) due to the heat when molded into a sheet shape or the like.

Examples of a specific method for the suspension attachment step include a method for sprinkling the adhesion preventive agent suspension onto the unvulcanized rubber with a shower device, and a dip method for immersing the unvulcanized rubber in a tank containing the adhesion preventive agent suspension for a short time. Moreover, a method for applying the adhesion preventive agent suspension onto the unvulcanized rubber using a coating device may be adopted, or these methods may be appropriately used in combination.

According to the disclosure, as described above, both adhesion prevention, and reduction of foreign substances caused by the adhesion preventive agent can be achieved. The reason (mechanism) why the adhesion preventive agent for unvulcanized rubber according to the disclosure exhibits such an effect is not necessarily clear, but is presumed as follows. That is, it is inferred that the component (B1), which is a metal soap, has an effect of effectively enhancing the attachment of the adhesion preventive agent to the surface of the unvulcanized rubber and allowing the adhesion preventive agent suspension to be evenly attached to the surface even if the amount of the component (A), which is a component responsible for developing adhesion prevention, is small. Therefore, according to the disclosure, it is presumed that an excellent adhesion preventive agent is obtained. Consequently, it is considered that the adhesion preventive agent suspension prepared from the adhesion preventive agent for unvulcanized rubber according to the disclosure suppresses foreign substances (for example, foreign substances on tires) caused by the adhesion preventive agent and efficiently covers the surface of the unvulcanized rubber, and thus favorable adhesion prevention is obtained. However, these matters are examples of presumed mechanisms, and do not limit the disclosure at all.

According to the disclosure, both the adhesion prevention and the reduction of foreign substances caused by the adhesion preventive agent, which were difficult to achieve in the related art, can be achieved. The kind of rubber to which the adhesion preventive agent for unvulcanized rubber according to the disclosure can be applied is not particularly limited, and any unvulcanized rubber may be used. Examples of the kind of the rubber include rubber, such as natural rubber (NR), butadiene rubber (BR), styrene butadiene rubber (SBR), butyl rubber (IIR), and ethylene propylene rubber (EPDM), and rubber obtained by mixing a plurality of kinds of rubber among them.

### EXAMPLE

Hereinafter, Examples of the disclosure will be described. However, the disclosure is not limited to the following Examples.

### Examples 1 to 16 and Comparative Examples 1 to 4

Respective components were kneaded in the weight (mass ratio) ratios shown in Tables 1 to 3 below to produce adhesion preventive agents for unvulcanized rubber of Examples 1 to 16 and Comparative Examples 1 to 4. Moreover, adhesion prevention, dried matter washability, dispersion solubility, and fluidity (liquid viscosity, that is, viscosity of an aqueous dispersion of an adhesion preventive agent for unvulcanized rubber having a concentration of 13% by mass) were evaluated by the methods shown in the following sections (1) to (4), respectively. Tables 1 to 3 below also show the results of these evaluations.

### EVALUATION

In various evaluations, the following unvulcanized SBR rubber and unvulcanized NR rubber were used as rubber for evaluations.

### (Unvulcanized SBR Rubber)

Unvulcanized SBR rubber obtained by blending 30 parts by mass of SAF carbon (produced by Mitsubishi Chemical Corporation, trade name “DIABLACK A”), 15 parts by mass of JSR AROMA (process oil) (produced by JAPAN SUN OIL COMPANY, LTD., trade name “AROMA 790”), 3 parts by mass of zinc oxide (produced by HAKUSUI TECH., two kinds of zinc oxide), 1 part by mass of stearic acid (produced by NOF CORPORATION, camellia japonica), 1 part by mass of 6PPD (produced by OUCHI SHINKO CHEMICAL INDUSTRIAL CO., LTD., trade name “NOCRAC 6C”), 1 part by mass of CBS (produced by OUCHI SHINKO CHEMICAL INDUSTRIAL CO., LTD., trade name “NOCCELER CZ-G”), and 1.5 parts by mass of sulfur (produced by Tsurumi Chemical Industry Co., Ltd.) (151.5 parts by mass in total), with respect to 100 parts by mass of SBR (produced by Asahi Kasei Corporation, trade name “TUFDENE 4850”).

### (Unvulcanized NR Rubber)

Unvulcanized NR rubber obtained by blending 10 parts by mass of white carbon (produced by Tosoh Silica Corporation, trade name “NIPSIL VN-3”), 30 parts by mass of ISAF black (produced by Tokai Carbon Co., Ltd., trade name “SEAST 6”), 15 parts by mass of JSR AROMA (process oil) (produced by JAPAN SUN OIL COMPANY, LTD., trade name “AROMA 790”), 3 parts by mass of zinc oxide (produced by HAKUSUI TECH., two kinds of zinc oxide), 1 part by mass of stearic acid (produced by NOF CORPORATION, camellia japonica), 1 part by mass of 6PPD (produced by OUCHI SHINKO CHEMICAL INDUSTRIAL CO., LTD., trade name “NOCRAC 6C”), 1 part by mass of CBS (produced by OUCHI SHINKO CHEMICAL INDUSTRIAL CO., LTD., trade name “NOCCELER CZ-G”), and 1.5 parts by mass of sulfur (produced by Tsurumi Chemical Industry Co., Ltd.) (162.5 parts by mass in total), with respect to 100 parts by mass of NR (RSS #3)

(1) Evaluation Method for Adhesion Prevention

The unvulcanized rubber was kneaded with an open roll having a temperature of 80° C. to 120° C. to form a rubber sheet (thickness: 5 to 8 mm, 60 cm×15 cm), and the rubber sheet immediately after being fed was immersed, for about 1 second, in 1 L of an adhesion preventive agent suspension (temperature of 40° C.) obtained by stirring and dispersing the adhesion preventive agent composition for unvulcanized rubber obtained in each of Examples 1 to 16 and Comparative Examples 1 to 4 in water for 1 hour or longer so as to have a concentration of 2% by mass. Thereafter, the immersed rubber sheet was quickly pulled up vertically, allowed to stand still vertically at room temperature, and air-dried.

Moreover, subsequently, the rubber sheet was cut into a size of 6 cm×15 cm, two sheets were overlapped to form a laminated state, and the resultant was used as a test piece. A load of 1 t/m² was applied to the test piece in the laminated state in the vertical direction from one surface thereof, and the test piece was left at 60° C. for 12 hours.

After leaving the test piece at 60° C. for 12 hours, the temperature of the test piece was returned to room temperature, a 180° peeling test was performed using a tensile tester [AGS-500D, Shimadzu Corporation], and a peeling resistance force (N/cm) was measured at a tensile speed of 300 mm/min. It was evaluated that the smaller the peeling effect, the better the adhesion prevention.

(2) Evaluation Method for Dried Matter Washability

A dried matter washing rate was calculated according to the following Mathematical Expression (X). It was evaluated that the larger the numerical value of the dried matter washing rate (%), the better the dried matter washability.

Dried matter washing rate (%)=(A−B)×100/A (X)

In Mathematical Expression (X), A is the mass (g) of a dried film obtained by carrying out the following steps (A1) to (A3) in this order.

(A1) The mass of a stainless steel plate (15 cm×6 cm, bright annealing treatment) was measured with an electronic balance [trade name “AX205”, Mettler-Toledo International Inc.].

(A2) 5 g of an adhesion preventive agent suspension (aqueous dispersion of the adhesion preventive agent for unvulcanized rubber), which was obtained by stirring and dispersing the adhesion preventive agent for unvulcanized rubber in water for 1 hour or longer so as to have a concentration of 5% by mass, was dropped to the half surface on the one side of the stainless steel plate of (A1) at 25° C. The dropped aqueous dispersion of the adhesion preventive agent for unvulcanized rubber was dried with a hot air dryer [trade name “PV-221”, ESPEC CORP.] at 55° C. for 120 minutes or longer to form a dried film on the stainless steel plate.

(A3) The mass of the stainless steel plate with a dried film obtained in the step (A2) was measured with an electronic balance [trade name “AX205”, Mettler-Toledo International Inc.]. A value obtained by subtracting the mass of the stainless steel plate alone measured in (A1) from the measured mass was taken as the mass A of the dried film.

In Mathematical Expression (X), B is the total weight (g) of the dried film, which had been washed with running water, obtained by carrying out the following steps (B1) to (B3) in this order at room temperature.

(B1) The dried film on the stainless steel plate was washed by allowing 200 mL of water to flow from the upper side of the stainless steel plate in a state of being tilted at 30° so that the dried film surface of the stainless steel plate with a dried film obtained in (A2) was the lower side.

(B2) The washing of (B1) was repeated 3 times in total.

(B3) The stainless steel plate washed in (B2) was dried with a hot air dryer [trade name “PV-221”, ESPEC CORP.] at 55° C. for 120 minutes or longer. Thereafter, the mass of the dried stainless steel plate was measured with an electronic balance [trade name “AX205”, Mettler-Toledo International Inc.]. A value obtained by subtracting the mass of the stainless steel plate alone measured in (A1) from the measured mass was taken as the mass B of the dried film which had been washed with running water.

(3) Evaluation Method for Dispersion Solubility

The residue rate of the adhesion preventive agent for unvulcanized rubber during dispersion and dissolution was calculated according to the following expression. It was evaluated that the smaller the numerical value of the residue rate (%), the better the dispersion solubility.

Residue rate (%)=C×100/21 (Y)

In Mathematical Expression (Y), C is the mass (g) of an adhesion preventive agent residue obtained by carrying out the following procedures (C1) to (C4) in this order.

(C1) The mass of an 80 nylon mesh was measured with an electronic balance.

(C2) 679 g of water at a temperature of 20° C. was put into a 1,000-mL beaker, and a stirrer equipped with one stage of four inclined paddle blades having a vertical length of 1 cm, a horizontal length of 4 cm, and an inclined angle of 45° was installed so that the distance from the bottom surface part of the beaker to the lower end of the four inclined paddle blades was 4.1 cm.

(C3) The total amount of 21 g of the adhesion preventive agent for unvulcanized rubber was put into the beaker within 5 seconds and stirred for 10 minutes, while rotating the four inclined paddle blades of (C2) at a rotation speed of 300 rpm.

(C4) After the stirring for 10 minutes in (C3), the obtained adhesion preventive liquid (aqueous dispersion of the adhesion preventive agent for unvulcanized rubber) was poured into a plastic container provided with the 80 nylon mesh of (C1). Subsequently, the mass of a product obtained by drying only the 80 nylon mesh at 70° C. for 12 hours was measured with an electronic balance. A value obtained by subtracting the mass of the 80 nylon mesh alone measured in (C1) from the measured mass was taken as the mass C of the residue of the adhesion preventive agent for unvulcanized rubber.

(4) Evaluation Method for Fluidity (Liquid Viscosity)

The viscosity (mPas) of an adhesion preventive agent suspension, which was obtained by stirring and dispersing the adhesion preventive agent composition for unvulcanized rubber in water for 1 hour or longer so as to have a concentration of 13% by mass, was measured with a BL-type viscometer in which the measurement temperature was 20° C., the rotor no. was 2, and the rotation speed was 6 rpm. It was evaluated that the smaller the numerical value of the measured viscosity, the better the fluidity.

TABLE 1

| | | Example | | | | | | |
|---|---|---|---|---|---|---|---|---|
| Component | | 1 | 2 | 3 | 4 | 5 | 6 | 7 |
| Component A | Smectite | 70 | 70 | 70 | 70 | 70 | 70 | 70 |
| | Hectorite | | | | | | | |
| Component B | PO 12-mol adduct of butyl alcohol | 2 | | | | | 0.1 | 5 |
| | PO 20-mol adduct of butyl alcohol | | 2 | | | | | |
| | PO 33-mol adduct of butyl alcohol | | | 2 | | | | |
| | PO 40-mol adduct of butyl alcohol | | | | 2 | | | |
| | PO 15-mol adduct of stearyl alcohol | | | | | 2 | | |
| Out of range of | PO 4-mol adduct of butyl alcohol | | | | | | | |
| component B | PO 45-mol adduct of butyl alcohol | | | | | | | |
| Component C | Nonionic surfactant | 5 | 5 | 5 | 5 | 5 | 5 | 5 |
| | Sodium α-olefin sulfonate | 3 | 3 | 3 | 3 | 3 | 3 | 3 |
| Component D | Kaolin clay | 10 | 10 | 10 | 10 | 10 | 11.9 | 7 |
| | Calcium carbonate | 5 | 5 | 5 | 5 | 5 | 5 | 5 |
| | Calcium stearate | 5 | 5 | 5 | 5 | 5 | 5 | 5 |
| Total (% by mass) | | 100 | 100 | 100 | 100 | 100 | 100 | 100 |
| Evaluation results | Dried matter washability | 72.1 | 95.9 | 98 | 78.3 | 81.3 | 86.3 | 97.3 |
| | (washing rate, %) | | | | | | | |
| | Dispersion solubility (residue rate, %) | 2.5 | 1.6 | 1.7 | 2.2 | 3.3 | 4.1 | 1.3 |
| | Adhesion prevention | 0.9 | 0.8 | 0.8 | 0.9 | 0.9 | 0.8 | 1.1 |
| | (2% dispersion, N/cm) | | | | | | | |
| | 13% liquid viscosity | 1,200 | 1,000 | 1,200 | 1,400 | 1,500 | 1,800 | 800 |
| | (after stirring for 1 hour, mPa · s) | | | | | | | |

TABLE 2

| | | Example | | | | | | |
|---|---|---|---|---|---|---|---|---|
| Component | | 8 | 9 | 10 | 11 | 12 | 13 | 14 |
| Component A | Smectite | 70 | 70 | 70 | | | 35 | 35 |
| | Hectorite | | | | 70 | 70 | 35 | 35 |
| Component B | PO 12-mol adduct of butyl alcohol | 2 | 2 | 2 | 2 | 5 | 2 | 5 |
| | PO 20-mol adduct of butyl alcohol | | | | | | | |
| | PO 33-mol adduct of butyl alcohol | | | | | | | |
| | PO 40-mol adduct of butyl alcohol | | | | | | | |
| | PO 15-mol adduct of stearyl alcohol | | | | | | | |
| Out of range of | PO 4-mol adduct of butyl alcohol | | | | | | | |
| component B | PO 45-mol adduct of butyl alcohol | | | | | | | |
| Component C | Nonionic surfactant | 5 | 5 | 5 | 5 | 5 | 5 | 5 |
| | Sodium α-olefin sulfonate | 3 | 3 | 3 | 3 | 3 | 3 | 3 |
| Component D | Kaolin clay | 10 | 10 | | 10 | 7 | 10 | 7 |
| | Calcium carbonate | 10 | | 10 | 5 | 5 | 5 | 5 |
| | Calcium stearate | | 10 | 10 | 5 | 5 | 5 | 5 |
| Total (% by mass) | | 100 | 100 | 100 | 100 | 100 | 100 | 100 |
| Evaluation results | Dried matter washability | 97.1 | 96.9 | 96.8 | 98.3 | 99.2 | 97.4 | 98.6 |
| | (washing rate, %) | | | | | | | |
| | Dispersion solubility (residue rate, %) | 1.5 | 2.1 | 2.4 | 1.4 | 0.8 | 1.0 | 0.8 |
| | Adhesion prevention | 1.0 | 0.7 | 0.9 | 1.7 | 2.3 | 1.4 | 1.2 |
| | (2% dispersion, N/cm) | | | | | | | |
| | 13% liquid viscosity | 1,300 | 1,600 | 1,600 | 600 | 400 | 900 | 600 |
| | (after stirring for 1 hour, mPa · s) | | | | | | | |

TABLE 3

| | | Example | | Comparative Example | | | |
|---|---|---|---|---|---|---|---|
| Component | | 15 | 16 | 1 | 2 | 3 | 4 |
| Component A | Smectite | 50 | 20 | 70 | 70 | 70 | 20 |
| | Hectorite | | | | | | |
| Component B | PO 12-mol adduct of butyl alcohol | 2 | 2 | | | | |
| | PO 20-mol adduct of butyl alcohol | | | | | | |
| | PO 33-mol adduct of butyl alcohol | | | | | | |
| | PO 40-mol adduct of butyl alcohol | | | | | | |
| | PO 15-mol adduct of stearyl alcohol | | | | | | |
| Out of range of | PO 4-mol adduct of butyl alcohol | | | | 5 | | |
| component B | PO 45-mol adduct of butyl alcohol | | | | | 5 | |
| Component C | Nonionic surfactant | 5 | 5 | 5 | 5 | 5 | 5 |
| | Sodium α-olefin sulfonate | 3 | 3 | 3 | 3 | 3 | 3 |
| Component D | Kaolin clay | 20 | 30 | 12 | 7 | 7 | 32 |
| | Calcium carbonate | 10 | 30 | 5 | 5 | 5 | 30 |
| | Calcium stearate | 10 | 10 | 5 | 5 | 5 | 10 |
| Total (% by mass) | | 100 | 100 | 100 | 100 | 100 | 100 |
| Evaluation results | Dried matter washability | 96.7 | 99.1 | 9 | 12 | 99.8 | 26 |
| | (washing rate, %) | | | | | | |
| | Dispersion solubility (residue rate, %) | 1.4 | 1.6 | 13.2 | 11.4 | 1.3 | 8.4 |
| | Adhesion prevention | 1.2 | 2.5 | 0.7 | 0.7 | Close | 2.3 |
| | (2% dispersion, N/cm) | | | | | adhesion | |
| | 13% liquid viscosity | 900 | 500 | 10,000 or | 10,000 | 1,000 | 5,000 |
| | (after stirring for 1 hour, mPa · s) | | | greater | | | |

As shown in Tables 1 to 3, the aqueous dispersions of an adhesion preventive agent for unvulcanized rubber of Examples containing all of the components (A) to (D) exhibited favorable adhesion prevention, fluidity, dispersion solubility, and dried matter washability. However, in both Comparative Examples 1 and 4 not containing the component (B), the liquid viscosity was too large, the fluidity was poor, and the dispersion solubility and the dried matter washability were also poor. Moreover, in Comparative Examples 2 and 3, the average addition molar number of PO in the contained alcohol PO adduct was outside the range of “12 to 40”, and thus the adduct did not correspond to the component (B). As a result, in Comparative Example 2 in which the average addition molar number of PO was too small, the liquid viscosity was too large, the fluidity was poor, and the dispersion solubility and the dried matter washability were also poor, as in Comparative Examples 1 and 4. Meanwhile, in Comparative Example 3 in which the average addition molar number of PO was too large, the adhesion prevention was poor, and the unvulcanized rubber and the unvulcanized rubber closely adhered to each other and could not be peeled.

What is claimed is:

1. An adhesion preventive agent for unvulcanized rubber, comprising components (A) to (D):
(A) a smectite;
(B) a compound represented by Chemical Formula (1),
R¹—O—(PO)m-H (1)
in Chemical Formula (1),
R¹ is a linear or branched hydrocarbon group having 4 to 20 carbon atoms,
PO is an oxypropylene group, and
m represents the average addition molar number of PO, and is a number of 12 to 40;
(C) a surfactant other than the component (B); and
(D) at least one substance selected from a group consisting of an inorganic silicate other than the component (A), an inorganic carbonate, an inorganic sulfate, a metal oxide, a metal hydroxide, red iron oxide, carbon black, graphite, and a metal soap.

2. The adhesion preventive agent for unvulcanized rubber according to claim 1,
wherein 20 to 80% by mass of the component (A), 0.1 to 5% by mass of the component (B), 5 to 20% by mass of the component (C), and 0.1% by mass or greater of the component (D) are contained with respect to 100% by mass of the total mass of the components other than water.

3. An aqueous dispersion of an adhesion preventive agent for unvulcanized rubber, comprising:
the adhesion preventive agent for unvulcanized rubber according to claim 1; and
water.

4. An aqueous dispersion of an adhesion preventive agent for unvulcanized rubber, comprising:
the adhesion preventive agent for unvulcanized rubber according to claim 2; and
water.
